(19) United States
(12) Patent Application Publication
(10) Pub. No.: US 2017/0368989 A1
(43) Pub. Date: Dec. 28, 2017

(54) SURFACE LIGHTING MODULE AND SURFACE LIGHTING SOURCE DEVICE FOR A VEHICLE USING THE SAME

(71) Applicant: Hyundai Motor Company, Seoul (KR)

(72) Inventor: Chan Hee KANG, Bucheon-si (KR)

(73) Assignee: Hyundai Motor Company, Seoul (KR)

(21) Appl. No.: 15/372,215

(22) Filed: Dec. 7, 2016

(30) Foreign Application Priority Data
Jun. 28, 2016 (KR) 10-2016-0081056

(51) Int. Cl. B60Q 3/10; F21V 8/00; B60Q 3/20

(52) U.S. Cl. CPC B60Q 3/10; B60Q 3/20; G02B 6/0073; G02B 6/0055; G02B 6/0063; G02B 6/0065

(57) ABSTRACT

A surface lighting module may include: a light source configured to emit light; a main reflection part configured to reflect light emitted from the light source; a light guiding part that is provided at an upper portion of the main reflection part and spreads light reflected from the main reflection part to have a surface shape; and a lateral reflection part that is attached to a lateral surface of the light guiding part and reflects light leaking to the lateral surface of the light guiding part.

### CROSS-REFERENCE TO RELATED APPLICATION

The present application claims priority to and the benefit of Korean Patent Application No. 10-2016-0081056 filed on Jun. 28, 2016, the entire contents of which are incorporated herein by reference.

### BACKGROUND OF THE INVENTION

### Field of the Invention

The present invention relates to a surface lighting module and a surface lighting source device for a vehicle using the same. More particularly, the present invention relates to a surface lighting module and a surface lighting source device for a vehicle using the same that may enhance marketability thereof and may reduce costs thereof by improving efficiency of surface lighting which may be generated by lighting devices for the vehicle used for various purposes.

### Description of Related Art

In general, for various purposes and for providing luxury senses to a user, a lighting module is applied to various components of a vehicle.

For example, a surface lighting modules forming surface lighting by uniformly spreading light is applied to various components of the vehicle so that a driver and a passenger may emotionally feel comfort.

In such a surface lighting module, it is a main characteristic thereof to provide uniform luminance or sufficient brightness on a predetermined surface.

There have been many attempts for manufacturing a surface lighting module with such a main characteristic.

A conventional surface lighting module spreads light of a light emitting diode (LED) through a reflector, or allows the light of the light emitting diode (LED) to pass through a light-diffusing lens or a light-diffusing plate.

Recently, by applying a backlighting technology for a light emitting diode television set (LED TV), a technology that allows the LED to provide surface lighting has been applied to vehicle components.

In the aforementioned technologies, important issues are associated with allowing the surface that emits light to have uniform brightness, and the backlighting technology as a technology for emitting light of the most uniform brightness allows the light of the LED to be emitted from a lateral surface of a light guide element.

However, the backlighting technology is required to use a plurality of LEDs to uniformly spread light to form surface lighting. Accordingly, it is necessary to reduce the number of the LEDs so that the backlighting technology may be generally used while improving marketability of a vehicle and reducing the costs, and it is necessary to prevent surface lighting quality and brightness characteristic thereof from deteriorating due to the reduction of the number of the LEDs.

In addition, as shown in FIG. 4 to FIG. 6, in symbol lighting of a conventional vehicle blind spot detection system (BSD), two LEDs 1 and 2 are used to secure light uniformity on a light emitting area.

However, since two or more LEDs 1 and 2 are used to cover a symbol area of the BSD with uniform lighting and to secure required brightness, costs of components thereof increase.

Further, according to a cross-sectional view of the BSD of the conventional art, light 3 emitted from the LED 1 is reflected by a reflection film 7 disposed at a bottom surface of a case 5, and then spreads at a predetermined angle through a light guide element 9 to form surface lighting, and then the light is collected through a prism 11 to increase surface luminance.

However, in the conventional BSD, since the light is not reflected by a lateral surface of the light guide element, light efficiency thereof deteriorates, and many LEDs should be used due to the deterioration of light efficiency, thereby increasing costs of components.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a surface lighting module and a surface lighting source device for a vehicle using the same that may improve efficiency of surface lighting, improve marketability thereof, and reduce costs thereof by configuring to be configured to reflect light leaking to a lateral surface of a light guide member thereof.

Various aspects of the present invention are directed to providing a surface lighting module including: a light source configured to emit light; a main reflection part configured to reflect light emitted from the light source; a light guiding part that is provided at an upper portion of the main reflection part and spreads light reflected from the main reflection part to have a surface shape; and a lateral reflection part that is attached to a lateral surface of the light guiding part and reflects light leaking to the lateral surface of the light guiding part.

The light source may include a light emitting diode (LED) as a surface lighting source.

The light guiding part may include a light guide material for allowing light reflected from the main reflection part to be a surface light source.

The lateral reflection part may include a reflection film for again reflecting light reflected to the lateral surface of the light guiding part to the inside of the light guiding part.

The reflection film of the lateral reflection part may include polyethylene terephthalate (PET).

The reflection film of the lateral reflection part may include a spherical silicon particle.

The light guiding part may be formed to have a quadrangular shape or a cylindrical shape.

When the light guiding part is formed to have the quadrangular shape, the light source may be positioned at a first lateral surface of the light guiding part, and the reflection film of the lateral reflection part may be attached to a second lateral surface of the light guiding part at which the light source is not positioned.

The reflection film of the lateral reflection part may be attached to three lateral surfaces of the light guiding part at which the light source is not positioned.

The reflection film of the lateral reflection part may be attached to four lateral surfaces including the lateral surface of the light guiding part at which the light source is positioned.

The reflection film of the lateral reflection part may be attached to all the lateral surfaces of the light guiding part excluding the light source.

When the light guiding part is formed to have the cylindrical shape, a reflection film of the lateral reflection part for reflecting light leaking to a circumferential surface of the light guiding part may be attached to the circumferential surface of the light guiding part.

The light source may be positioned at some of the circumferential surface of the light guiding part, and the reflection film of the lateral reflection part may be attached to a remaining part of the circumferential surface of the light guiding part at which the light source is not positioned.

The reflection film of the lateral reflection part may be partially or entirely attached to the circumferential surface of the light guiding part excluding the light source.

Another exemplary embodiment of the present invention provides a surface lighting source device for a vehicle including the surface lighting module.

According to the embodiment of the present invention, it is possible to minimize the number of LEDs, to improve fuel efficiency due to the reduction of the number of components of the surface lighting module, and reduce a size, thickness, and weight of components of the vehicle, by adding a reflector that may reflect light leaking to a lateral surface of a light guide member.

Moreover, it is possible to prevent light from leaking by reflecting the light leaking to the lateral surface of the light guide member through the side reflector, that is, it is possible to improve light extraction efficiency.

Further, light color differences between respective LEDs decrease according to the reduction of the LEDs, thereby improving light color quality, and increase of operation temperature of the LEDs is limited according to the reduction of the LEDs, thereby improving durability of a surface lighting module and a surface lighting source device for a vehicle using the same.

Further, the surface lighting module and the surface lighting source device for the vehicle using the same according to the exemplary embodiment of the present invention may be, for example, applied to a light source unit of positioning lamps of a vehicle, a light source unit of side marker lamps of a vehicle, a light source unit of turn signal lamps of a vehicle, a light source unit of tail lamps and stop lamps which are combination lamps of a vehicle, a light source unit of a high mounted stop lamp of a vehicle, a light source unit of a vehicle blind spot detection system of a vehicle, a light source unit of a make-up lamp of a vehicle, a light source unit of an overhead console lamp of a vehicle, a light source unit of a room lamp of a vehicle, a light source unit of a personal lamp of a vehicle, and the like.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a top plan view of a surface lighting module according to an exemplary embodiment of the present invention.

FIG. 2 illustrates a side cross-sectional view of a surface lighting module according to an exemplary embodiment of the present invention.

FIG. 3 illustrates a schematic partial perspective view of a surface lighting module according to an exemplary embodiment of the present invention.

FIG. 4 illustrates a top plan view of a surface lighting module according to a conventional art.

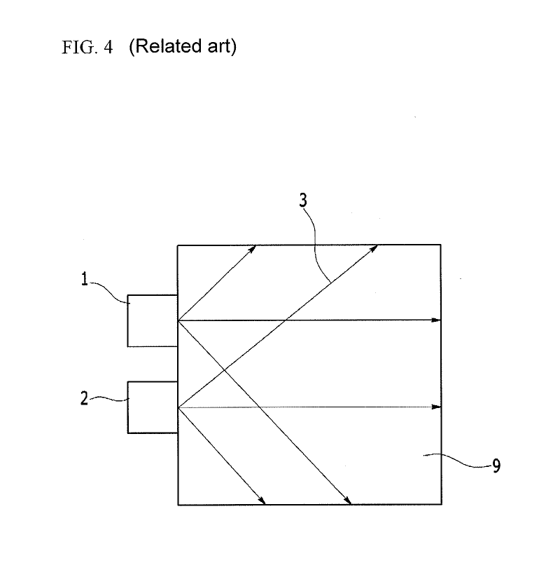

FIG. 5 illustrates a side cross-sectional view of a surface lighting module according to a conventional art.

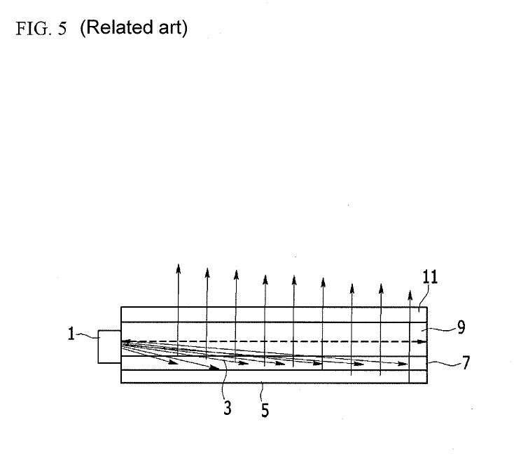

FIG. 6 illustrates a schematic perspective view of a surface lighting module according to a conventional art.

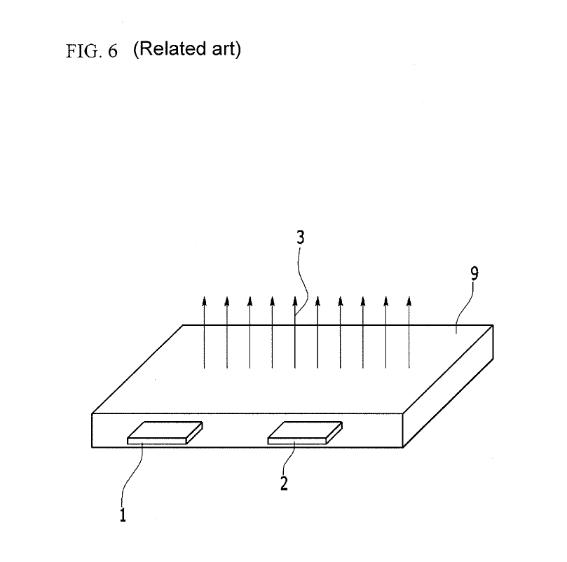

FIG. 7 illustrates a photograph of a surface lighting result (luminance) using a surface lighting module according to an exemplary embodiment of the present invention.

FIG. 8 illustrates a photograph of a surface lighting result (luminance) using a surface lighting module according to a conventional art.

FIG. 9 illustrates a schematic partial perspective view of a surface lighting module according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

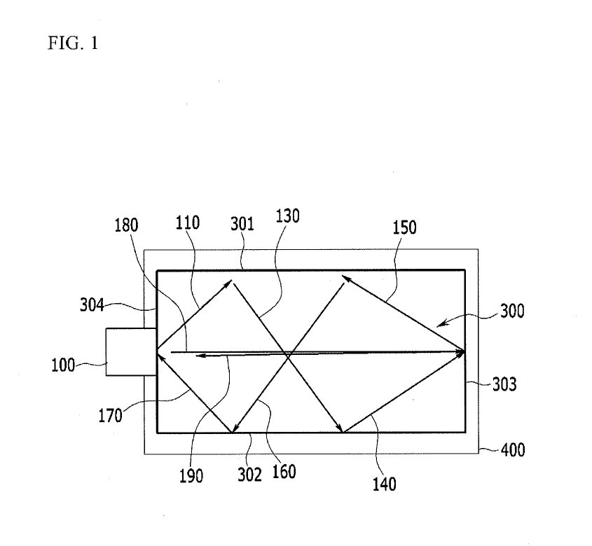

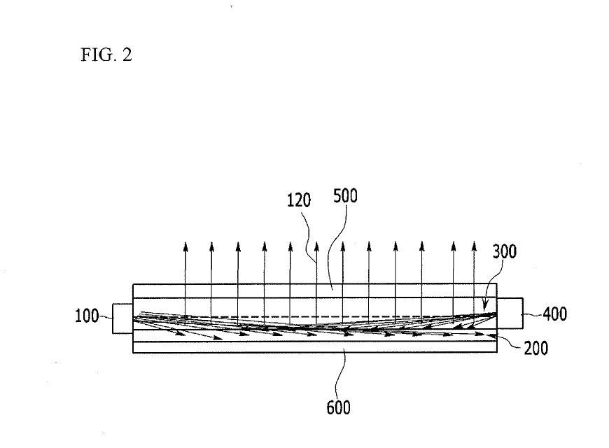

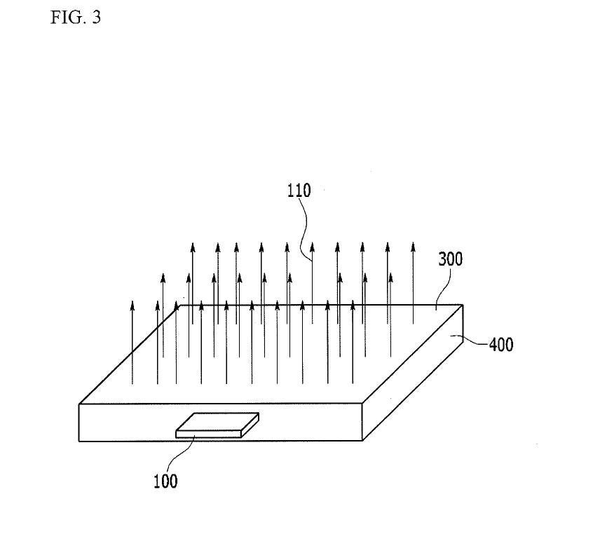

FIG. 1 illustrates a top plan view of a surface lighting module according to an exemplary embodiment of the present invention, FIG. 2 illustrates a side cross-sectional view of a surface lighting module according to an exemplary embodiment of the present invention, and FIG. 3 illustrates a schematic partial perspective view of a surface lighting module according to an exemplary embodiment of the present invention.

As shown in FIG. 1 to FIG. 3, a surface lighting module according to an exemplary embodiment of the present invention may include a light source 100 for emitting light 110, a main reflection part 200 for reflecting the light 110 emitted from the light source 100, a light guiding part 300 provided on the main reflection part 200 and that spreads light reflected from the main reflection part 200 to have a surface shape, and a lateral reflection part 400 attached to a lateral surface of the light guiding part 300 and that reflects light leaking to the lateral surface of the light guiding part 300.

A prism 500, which is provided on the light guiding part 300 and increases surface illuminance by collecting light, may be included.

The light source 100 may include light emitting diodes (LEDs) as surface lighting sources.

The main reflection part 200 may include a reflection film for reflecting light. The main reflection part 200 may be positioned on a base member 600.

The light guiding part 300 may include a light guide element that allows the light 110 reflected from the main reflection part 200 to be surface lighting.

The lateral reflection part 400 may be formed to include a reflection film and the for reflecting the light reflected from the lateral surface of the light guiding part 300 to the inside of the light guiding part.

The reflection film of the lateral reflection part 400 may include polyethylene terephthalate (PET) or the like which may reflect light.

Further, the reflection film of the lateral reflection part 400 may include a spherical silicon particle of a predetermined size (diameter) so the light may be easily reflected.

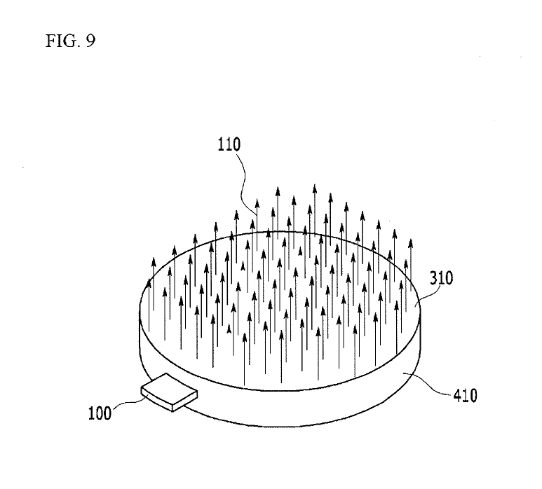

The light guiding part may be formed to have a quadrangular shape as shown in FIG. 1 to FIG. 3, or a cylindrical shape as shown in FIG. 9.

When the light guiding part 300 is formed to have the quadrangular shape, the light source 100 is positioned at a first lateral surface of the light guiding part 300, and the reflection film of the lateral reflection part 400 may be attached to another lateral surface of the light guiding part 300 at which the light source 100 is not positioned so that the light leaking to the lateral surface of the light guiding part 300 may be easily again reflected to the inside of the light guiding part 300, wherein the reflection film may be attached to a third lateral surface of the light guiding part 300 at which the light source 100 is not positioned, it may be attached to a fourth lateral surface including a lateral surface of the light guiding part 300 at which the light source 100 is positioned, or it may be attached to the whole lateral surfaces of the light guiding part 300 excluding the light source 100.

In addition, a surface lighting source device for a vehicle using the surface lighting module may include a configuration of the surface lighting module.

Operations of the surface lighting module according to the exemplary embodiment of the present invention will now be described with reference to FIG. 1 to FIG. 3.

Although it will be exemplarily described that the light guiding part 300 is formed to have the quadrangular shape herein, it may be applied to the case that the light guiding part is formed to have the cylindrical shape.

First, when the light 110 is emitted from the LED of the light source 100 and the emitted light 110 is inputted to the main reflection part 200, as shown in FIG. 2, the inputted light 100 is reflected by the reflection film of the main reflection part 200, and then it spreads as vertical light 120 directed in a direction perpendicular to the main reflection part 200 to have a surface shape through the light guide element of the light guiding part 300.

In this case, the light 110 leaking to the lateral surface of the light guiding part 300, that is, the light 110 reaching one lateral surface 301 of the light guiding part 300, is reflected by the reflection film of the lateral reflection part 400 attached to the lateral surface of the light guiding part 300, and then is incident on another lateral surface 302 facing one lateral surface of the light guiding part.

Further, light 130 incident on a second lateral surface 302 of the light guiding part 300 by the lateral reflection part 400 is again reflected by the lateral reflection part 400 to be incident on a lateral surface 303 adjacent to the second lateral surface 302 of the light guiding part 300.

Light 140 incident on the lateral surface 303 adjacent to the second lateral surface 302 of the light guiding part 300 is again reflected by the lateral reflection part 400 to be incident on the first lateral surface 301 of the light guiding part 300, and light 150 incident on the first lateral surface 301 of the light guiding part 300 is again reflected by the lateral reflection part 400 to be incident on the second lateral surface 302 of the light guiding part 300, that is, on the surface facing the first lateral surface of the light guiding part.

Light 160 incident on the second lateral surface 302 of the light guiding part 300 is again reflected by the lateral reflection part 400 to be incident on a lateral surface 304 of the light guiding part 300 at which the light source 100 is positioned, and light 170 incident on the lateral surface 304 of the light guiding part 300 is again reflected by the lateral reflection part 400 to be incident on one lateral surface of the light guiding part 300.

Light 180 emitted from the light source is directly incident on the lateral surface 303 of the light guiding part facing the lateral surface 304 of the light guiding part at which the light source is positioned, and then is again reflected by the lateral reflection part 400. Light 190 reflected by the lateral surface of the light guiding part is again incident on the lateral surface 304 of the light guiding part 300 at which the light source 100 is positioned.

As described above, according to the exemplary embodiment of the present invention, since the light leaking to the lateral surface of the light guiding part 300 is again reflected into the light guiding part 300 by the reflection film of the lateral reflection part 400 attached to the lateral surface of the light guiding part 300, luminance uniformity and brightness may be improved compared to the conventional art.

In the exemplary embodiment of the present invention, for example, one LED is used in the symbol lighting component of the BSD, and the light reflection film of the lateral reflection part is attached to the lateral surfaces of the light guiding part (three lateral surfaces or four lateral surfaces excluding the light source), thereby realizing the uniform surface lighting with one LED, securing substantially the same light distribution as the conventional art using at least two LEDs by preventing the light from leaking through the light reflection, and reducing the number of LEDs.

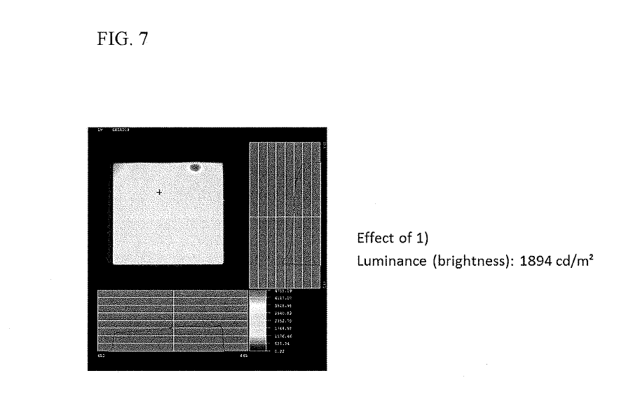

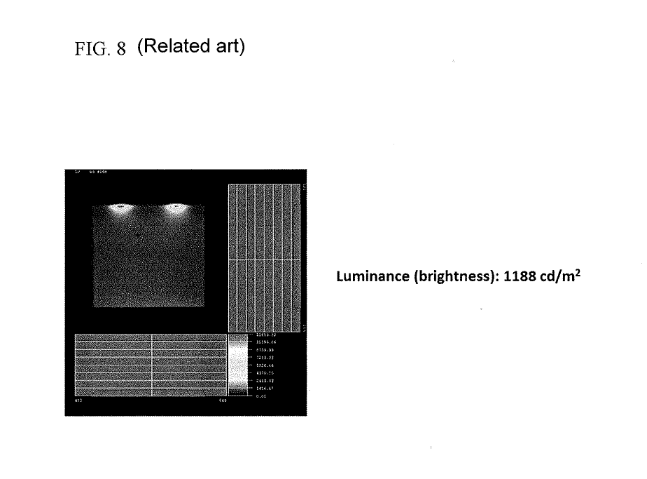

The surface lighting module according to the exemplary embodiment of the present invention is compared with the surface lighting module according to the conventional art based on evaluation results (effects) with reference to FIG. 7 and FIG. 8.

In the surface lighting module according to the exemplary embodiment of the present invention, one LED is used, and a reflection film is attached to the lateral surface of the light guiding part.

In the surface lighting module according to the conventional art, two LEDs are used, and no reflection film is attached to the lateral surface of the light guiding part.

That is, in the surface lighting module according to the exemplary embodiment of the present invention, since the reflection film of the lateral reflection part is attached to the lateral surface of the light guiding part so that the light leaking to the light guiding part may be reflected, even though only one LED is used, the luminance (brightness) and the light uniformity of the surface lighting module according to the exemplary embodiment of the present invention increase or are improved compared to the surface lighting module according to the conventional art.

FIG. 9 illustrates a schematic partial perspective view of a surface lighting module according to another exemplary embodiment of the present invention.

A surface lighting module according to another exemplary embodiment of the present invention is the same as the surface lighting module according to the exemplary embodiment of the present invention described above other than features to be described below, thus a repeated description will be omitted.

Referring to FIG. 9, a light guiding part 310 of a surface lighting module according to another exemplary embodiment of the present invention may be formed to have a cylindrical shape, and a lateral reflection part 410 for reflecting light leaking to a circumferential surface of the light guiding part 310 may be attached to the circumferential surface of the light guiding part 310.

When the light guiding part 310 is formed to have the cylindrical shape, the light source 100 is positioned at some of the circumferential surface of the light guiding part 310, and the reflection film of the lateral reflection part 410 may be attached to other portions of the circumferential surface of the light guiding part 310 at which the light source 100 is not positioned so that the light leaking to the circumferential surface of the light guiding part 310 may be reflected inside the light guiding part 310, or it may be partially or entirely attached to the circumferential surface of the light guiding part 310 excluding the light source 100.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A surface lighting module comprising:
a light source configured to emit light;
a main reflection part configured to reflect the light emitted from the light source;
a light guiding part that is provided at an upper portion of the main reflection part and spreads light reflected from the main reflection part to have a surface shape; and
a lateral reflection part that is attached to a lateral surface of the light guiding part and reflects light leaking to the lateral surface of the light guiding part.

2. The surface lighting module of claim 1, wherein
the light source includes a light emitting diode (LED) as a surface lighting source.

3. The surface lighting module of claim 2, wherein
the light guiding part includes a light guide material for allowing light reflected from the main reflection part to be the surface light source.

4. The surface lighting module of claim 3, wherein
the lateral reflection part includes a reflection film for again reflecting light reflected to the lateral surface of the light guiding part to an inside of the light guiding part.

5. The surface lighting module of claim 4, wherein
the reflection film of the lateral reflection part includes polyethylene terephthalate (PET).

6. The surface lighting module of claim 5, wherein
the reflection film of the lateral reflection part includes a spherical silicon particle.

7. The surface lighting module of claim 4, wherein
the light guiding part is formed to have a quadrangular shape or a cylindrical shape.

8. The surface lighting module of claim 7, wherein
when the light guiding part is formed to have the quadrangular shape, the light source is positioned at a first lateral surface of the light guiding part, and the reflection film of the lateral reflection part is attached to a second lateral surface of the light guiding part at which the light source is not positioned.

9. The surface lighting module of claim 8, wherein
the reflection film of the lateral reflection part is attached to three lateral surfaces of the light guiding part at which the light source is not positioned.

10. The surface lighting module of claim 9, wherein
the reflection film of the lateral reflection part is attached to four lateral surfaces including the lateral surface of the light guiding part at which the light source is positioned.

11. The surface lighting module of claim 10, wherein
the reflection film of the lateral reflection part is attached to all of the lateral surfaces of the light guiding part excluding the light source.

12. The surface lighting module of claim 7, wherein
when the light guiding part is formed to have the cylindrical shape, a reflection film of the lateral reflection part for reflecting light leaking to a circumferential surface of the light guiding part is attached to the circumferential surface of the light guiding part.

13. The surface lighting module of claim 12, wherein
the light source is positioned at a first portion of the circumferential surface of the light guiding part, and the reflection film of the lateral reflection part is attached to a second portion of the circumferential surface of the light guiding part at which the light source is not positioned.

14. The surface lighting module of claim 13, wherein
the reflection film of the lateral reflection part is partially or entirely attached to the circumferential surface of the light guiding part excluding the light source.

15. A surface lighting source device for a vehicle including the surface lighting module of claim 1.
